(19) United States
(12) Patent Application Publication
(10) Pub. No.: US 2006/0030353 A1
(43) Pub. Date: Feb. 9, 2006

(54) Apparatus and method for controlling power in sleep mode in a mobile communication terminal

(75) Inventor: Si-Bum Jun, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Gyeonggi-do (KR)

(21) Appl. No.: 11/221,665

(22) Filed: Sep. 8, 2005

(30) Foreign Application Priority Data
Aug. 9, 2004 (KR) 2004-71779

(51) Int. Cl. H04B 1/38

(52) U.S. Cl. 455/550.1; 455/574

(57) ABSTRACT

An apparatus and method are provided for controlling power in sleep mode in a mobile communication terminal. A radio communicator including a power supply converts a radio signal received through an antenna into a baseband signal using a reference oscillating frequency of a voltage controlled oscillator. A radio frequency identification (RFID) tag generates power using an interrogation signal from a base station, and outputs a “wake-up” signal to be used to determine whether a radio signal has been received using the generated power. A controller controls the power supply to supply the power to the radio communicator in response to the wake-up signal from the RFID tag. Accordingly, an amount of power consumption in the mobile communication terminal can be reduced.

### PRIORITY

This application claims priority to an application entitled “APPARATUS AND METHOD FOR CONTROLLING POWER IN SLEEP MODE IN A MOBILE COMMUNICATION TERMINAL”, filed in the Korean Intellectual Property Office on Sep. 8, 2004 and assigned Serial No. 2004-71779, the contents of which are incorporated herein by reference.

### BACKGROUND OF THE INVENTION

1. Field of the Invention

The present invention relates generally to an apparatus and method for controlling power in sleep mode in a mobile communication terminal, and more particularly to a power control apparatus and method for minimizing power consumption when a mobile communication terminal operates in a sleep mode.

2. Description of the Related Art

With the development of communication technology, mobile communication terminals have become more commonplace. Mobile communication terminals, such as mobile phones or personal digital assistants (PDAs), are devices which can provide a telephone communication function to users wherever they may be. Mobile communication terminals generally receive power from one or more a rechargeable batteries. However, the power capacity of a rechargeable battery is limited. Battery power consumption, or draw, is a factor which limits the available operating time of the mobile communication terminal. Accordingly, various methods for reducing power consumption of mobile communication terminals are being developed.

When the mobile communication terminal is not engaged in a telephone communication function or other such function, it operates in a sleep mode. In the sleep mode, the mobile communication terminal non-essential operations and operates intermittently to determine whether a signal destined for a radio receiver of the terminal has been received of a predetermined time interval, thereby reducing unnecessary power consumption.

When the mobile communication terminal conventionally operates in the sleep mode, it periodically generates a wake-up signal at a predetermined time interval using a timing signal of a low frequency oscillator, for example, a real time clock (RTC), and supplies power to the radio receiver according to the generated wake-up signal. Accordingly, the radio receiver determines if a signal destined for the receiver has been received from a base station.

However, in the conventional mobile communication terminal, the low frequency oscillator must always be in an ON state in the sleep mode to output a timing signal for generating the wake-up signal at the predetermined time interval, resulting in unnecessary power consumption. Accordingly, if the power required for turning on the low frequency oscillator in the sleep mode was reduced, the amount of power consumption in the mobile communication terminal could be significantly reduced.

### SUMMARY OF THE INVENTION

Accordingly, the present invention solves the above and other problems occurring in the prior art. Therefore, it is an aspect of the present invention to provide a power control apparatus and method that reduce the amount of power consumption when a mobile communication terminal operates in a sleep mode.

It is another aspect of the present invention to provide a power control apparatus and method that reduce the amount of power consumption by using a radio frequency identification (RFID) tag capable of generating power by itself according to an external radio wave, rather than using a low frequency oscillator that must be always turned on in a sleep mode in a mobile communication terminal.

The above and other aspects of the present invention can be achieved by an apparatus for controlling power in a sleep mode in a mobile communication terminal. The apparatus includes a radio communicator for converting a radio signal received through an antenna into a baseband signal using a reference oscillating frequency of a voltage controlled oscillator, a power supply for supplying power to the radio communicator, a radio frequency identification (RFID) tag for receiving an interrogation signal from a base station to generate power, and outputting a wake-up signal to be used to determine whether a radio signal has been received using the generated power, and a controller for controlling the power supply to supply the power to the radio communicator in response to the wake-up signal from the RFID tag.

The above and other aspects of the present invention can be achieved by a method for controlling power in a sleep mode in a mobile communication terminal. The method includes receiving, from a base station, an interrogation signal for power control in the sleep mode, generating power using the received interrogation signal, and generating a wake-up signal to determine if a radio signal has been received using the generated power.

The above and other aspects of the present invention can be achieved by a method for controlling power in a sleep mode in a mobile communication terminal. The method includes receiving, from a base station, an interrogation signal in the sleep mode, the interrogation signal including at least one specific terminal identification (ID), generating power using the received interrogation signal, determining if the terminal's own ID is included in the interrogation signal using the generated power, and when the terminal's own ID is included in the interrogation signal, generating a wake-up signal to determine if a radio signal has been received.

### BRIEF DESCRIPTION OF THE DRAWINGS

The above and other aspects and advantages of the present invention will be more clearly understood from the following detailed description taken in conjunction with the accompanying drawings, in which:

FIG. 1 illustrates a wireless network in accordance with an embodiment of the present invention;

FIG. 2 is a block diagram illustrating an apparatus for controlling power in sleep mode in a mobile communication terminal in accordance with an embodiment of the present invention;

FIG. 3 is a flow chart illustrating a process for outputting, from a base station, an interrogation signal to control power of the mobile communication terminal in accordance with a first embodiment of the present invention;

FIG. 4 is a flow chart illustrating a process for controlling power according to a received interrogation signal in a sleep mode in the mobile communication terminal in accordance with the first embodiment of the present invention;

FIG. 5 is a timing diagram illustrating the power control process based on the received interrogation signal in the sleep mode in the mobile communication terminal in accordance with the first embodiment of the present invention;

FIG. 6 is a flow chart illustrating a process for outputting, from the base station, an interrogation signal to control power of the mobile communication terminal in accordance with a second embodiment of the present invention;

FIG. 7 is a flow chart illustrating a process for controlling power according to a received interrogation signal in the sleep mode in the mobile communication terminal in accordance with the second embodiment of the present invention; and

FIG. 8 is a timing diagram illustrating the power control process based on the received interrogation signal in the sleep mode in the mobile communication terminal in accordance with the second embodiment of the present invention.

### DETAILED DESCRIPTION OF THE PREFERRED EMBODIMENTS

Preferred embodiments of the present invention will be described in detail herein below with reference to the accompanying drawings. In the following description, a detailed description of known functions and configurations incorporated herein will be omitted for conciseness.

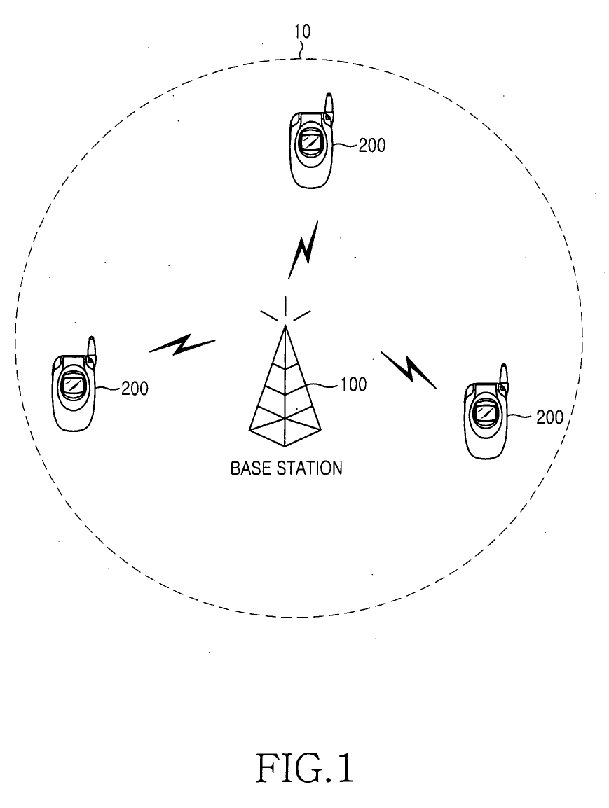

FIG. 1 illustrates a wireless network in accordance with an embodiment of the present invention. The wireless network 10 has a small cell radius of approximately ten meters as compared with a code division multiple access (CDMA) wireless network. In accordance with the embodiment of the present invention, the wireless network 10 can be a wireless personal area network (WPAN) having various standards ranging from an ultra-low speed standard to an ultra-high speed standard. For example, the low speed standard used in the wireless network may be IEEE 802.15.4 (ZigBee), and the high speed standard used in the wireless network may be IEEE 802.15.3a (ultra-wide band (UWB)).

In accordance with the embodiment of the present invention, a base station 100 of the wireless network 10 transmits an interrogation signal such that mobile communication terminals 200 located in an area covered by the base station 100 generate a wake-up signal in sleep mode. The wake-up signal is a control signal for controlling the supply power to a radio receiver in the sleep mode such that a mobile communication terminal 200 determines whether a signal destined for the terminal 200 has been received.

Each terminal 200 receives the interrogation signal from the base station 100 through a radio frequency identification (RFID) tag in the sleep mode, generates direct current (DC) power by itself, and generates a wake-up signal to determine whether a signal destined for each terminal has been received using the generated DC power.

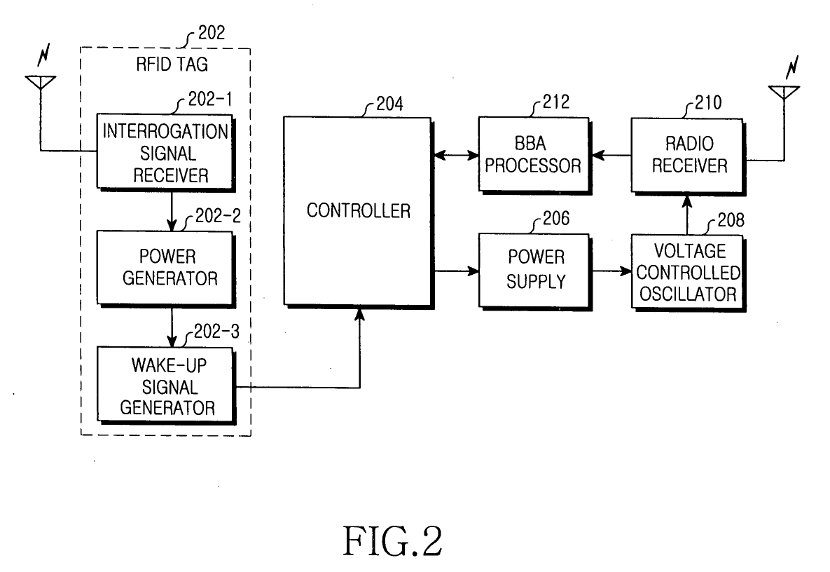

FIG. 2 is a block diagram illustrating an apparatus for controlling power in the sleep mode in the mobile communication terminal in accordance with an embodiment of the present invention. The apparatus for controlling power in the sleep mode in the mobile communication terminal includes an RFID tag 202, a controller 204, a power supply 206, a voltage controlled oscillator 208, a radio receiver 210, and a baseband analog (BBA) processor 212.

The RFID tag 202 is a passive RFID tag. The RFID tag 202 receives an interrogation signal from the base station 100, and generates DC power by itself using a received radio frequency (RF) signal. The RFID tag 202 generates and outputs a wake-up signal using the generated DC power. The RFID tag 202 includes an interrogation signal receiver 202-1 for receiving the interrogation signal, a power generator 202-2 for converting the received interrogation signal into the DC to generate the DC power, and a wake-up signal generator 202-3 for receiving the DC power from the power generator 202-2 to generate and output the wake-up signal.

The controller 204 controls overall operation of the mobile communication terminal 200. In the sleep mode, the controller 204 outputs a power control signal to determine whether a signal destined for the terminal 200 has been received in response to the wake-up signal output from the wake-up signal generator 202-3. If a signal destined for the terminal 200 has been received, the controller 204 terminates the sleep mode. However, if a signal destined for the terminal 200 has not been received, the controller 204 maintains the sleep mode.

In response to the power control signal output from the controller 204, the power supply 206 supplies power to the voltage controlled oscillator 208, and turns it on. When in the on state the voltage controlled oscillator 208 provides an internal reference clock to the radio receiver 210. The radio receiver 210 converts a radio signal received through an antenna into an intermediate frequency (IF) using an oscillating frequency generated by the voltage controlled 208, and outputs the IF signal to the BBA processor 212. The BBA processor 212 converts the received IF signal into a baseband signal, and transfers the baseband signal to the controller 204. In the sleep mode, the controller 204 determines whether a signal destined for the terminal 200 has been received through the baseband signal transferred from the BBA processor 212.

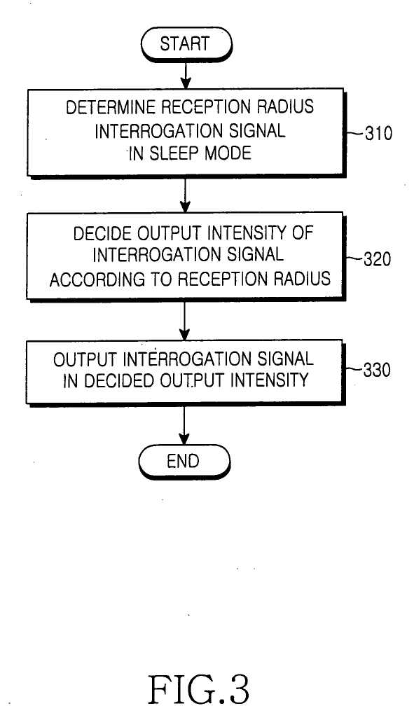

A method for controlling power in the mobile communication terminal 200 in accordance with a first embodiment of the present invention will now be described with reference to FIGS. 3 to 5.

FIG. 3 is a flow chart illustrating a process for outputting, from the base station 100, an interrogation signal to control power of the mobile communication terminal 200 in accordance with the first embodiment of the present invention. The base station 100 determines a reception radius for the interrogation signal to control power of the mobile communication terminal 200 in step 310. The base station 100 decides an output intensity of the interrogation signal on the basis of the reception radius for the interrogation signal in step 320. The base station 100 outputs the interrogation signal in the decided output intensity in step 330.

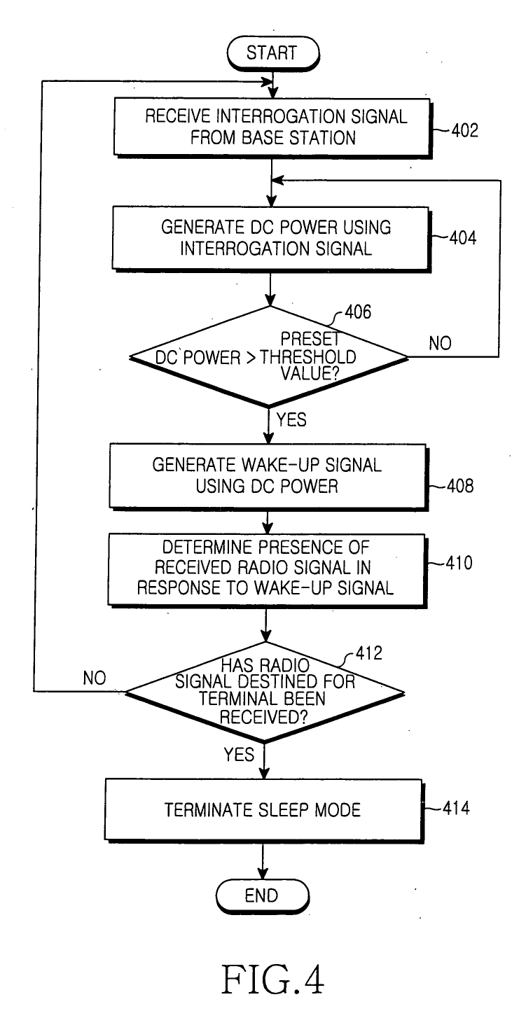

FIG. 4 is a flow chart illustrating a process for controlling power according to a received interrogation signal in the sleep mode in the mobile communication terminal 200 in accordance with the first embodiment of the present invention. In the sleep mode, the mobile communication terminal 200 receives the interrogation signal from the base station 100 and controls power accordingly. The mobile communication terminal 200 receives the interrogation signal output from the base station 100 in step 402. Subsequently, the mobile communication terminal 200 generates DC power using the received interrogation signal in step 404. The mobile communication terminal 200 then determines whether a value of the generated DC power is greater than a preset threshold value, that is, a threshold power value, in step 406. If the value of the generated DC power is less than or equal to the preset threshold value, the mobile communication terminal 200 repeats the process for generating the DC power in step 404. However, if the value of the generated DC power is greater than the preset threshold value, the mobile communication terminal 200 generates the wake-up signal for power control using the DC power in step 408. Then, the mobile communication terminal 200 supplies power to the voltage controlled oscillator 208 in response to the wake-up signal such that a determination can be made as to whether a radio signal has been received in step 410. If it is determined that a radio signal destined for the terminal 200 has been received in step 412, the mobile communication terminal 200 proceeds to step 414 to terminate the sleep mode. However, if it is determined that a radio signal destined for the terminal 200 has not been received in step 412, the mobile communication terminal 200 maintains the sleep mode to return to step 402.

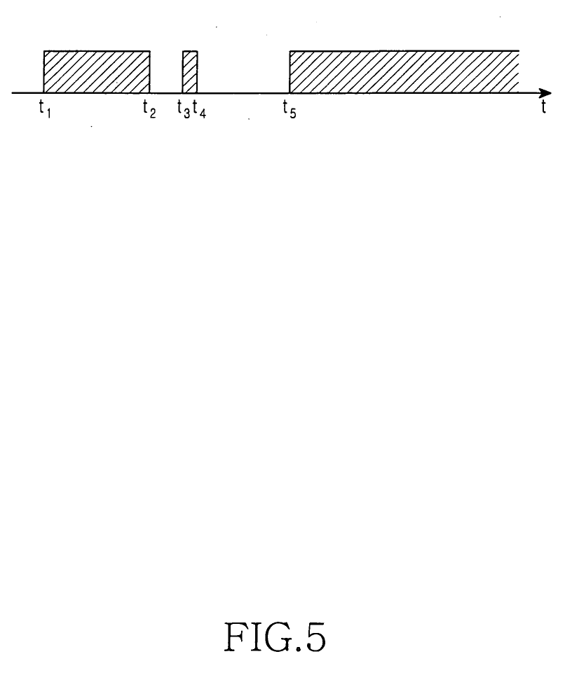

FIG. 5 is a timing diagram illustrating the power control process based on the received interrogation signal in the sleep mode in the mobile communication terminal 200 in accordance with the first embodiment of the present invention. A time period between t1 and t2 is a time period in which the mobile communication terminal 200 receives an interrogation signal and generates DC power. A time period between t2 and t3 is a time period in which a value of the generated DC power is incremented to a predetermined threshold value. A time period between t3 and t4 is a time period in which a wake-up signal is output. A time period between t4 and t5 is a time period in which the radio receiver 210 is powered on in response to the wake-up signal. A time period between t5 and is a time period in which a determination is made as to whether the radio receiver 210 has received a radio signal.

Because the mobile communication terminal 200 receives an interrogation signal to generate power and generates a wake-up signal using the generated power in accordance with the first embodiment of the present invention, it can reduce an amount of battery power consumption, as compared with the conventional mobile communication terminal for periodically generating the wake-up signal.

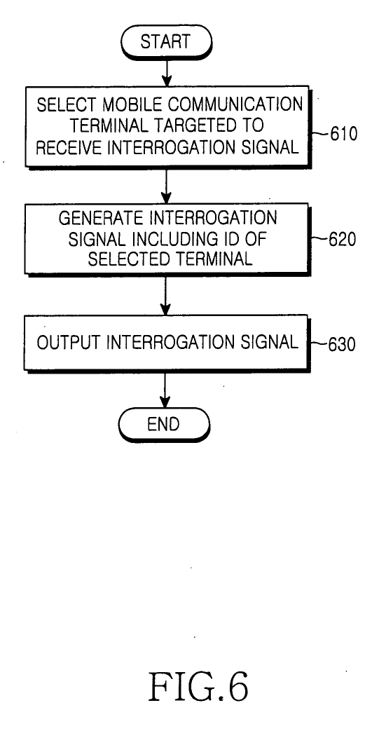

A method for controlling power in the mobile communication terminal 200 in accordance with a second embodiment of the present invention will now be described with reference to FIGS. 6 to 8.

FIG. 6 is a flow chart illustrating a process for outputting, from the base station 100, an interrogation signal to control power of the mobile communication terminal 200 in accordance with the second embodiment of the present invention. The base station 100 selects a mobile communication terminal 200 targeted to receive an interrogation signal in step 610. Subsequently, the base station 100 generates the interrogation signal including an identification (ID) of the selected terminal 200 in step 620. Subsequently, the base station 100 outputs the generated interrogation signal in step 630.

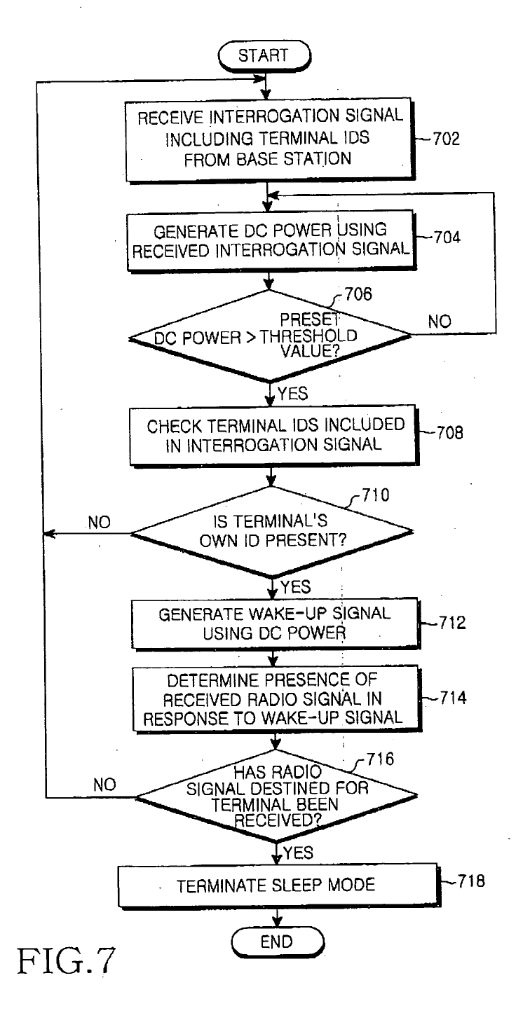

In the sleep mode, the mobile communication terminal 200 receives the interrogation signal from the base station 100 and controls power thereof. FIG. 7 is a flow chart illustrating a process for controlling power according to the received interrogation signal in the sleep mode in the mobile communication terminal 200 in accordance with the second embodiment of the present invention. The mobile communication terminal 200 receives the interrogation signal including terminal IDs from the base station 100 in step 702. Subsequently, the mobile communication terminal 200 generates DC power using the received interrogation signal in step 704. Subsequently, the mobile communication terminal 200 determines whether a value of the generated DC power is greater than a preset threshold value, that is, a threshold power value, in step 706. If the value of the generated DC power is less than or equal to the preset threshold value, the mobile communication terminal 200 repeats the process for generating the DC power in step 704. However, if the value of the generated DC power is greater than the preset threshold value, the mobile communication terminal 200 checks the terminal IDs included in the interrogation signal in step 708. In step 716, the mobile communication terminal 200 determines whether its own ID is present among the terminal IDs included in the interrogation signal. If the terminal's own ID is not included in the interrogation signal, the mobile communication terminal 200 returns to step 702. However, if the terminal's own ID is present among the terminal IDs included in the interrogation signal, the mobile communication terminal 200 proceeds to step 712. The mobile communication terminal 200 generates a wake-up signal for controlling power of the terminal 200 using the DC power in step 712. In response to the wake-up signal, the mobile communication terminal 200 determines whether a radio signal has been received in step 714. That is, the mobile communication terminal 200 supplies power to the voltage controlled oscillator (VCO) 208 in response to the wake-up signal so that the voltage controlled oscillator generates a reference oscillating frequency to operate the radio receiver 210. According to the operation of the radio receiver 210, the mobile communication terminal 200 checks a signal output from the BBA processor 212.

After determining whether a radio signal has been received, the mobile communication terminal 200 determines whether a radio signal destined for the terminal 200 has been received in step 716. If a radio signal destined for the terminal 200 has been received, the mobile communication terminal 200 proceeds to step 718 to terminate the sleep mode. However, if a radio signal destined for the terminal has not been received, the mobile communication terminal 200 maintains the sleep mode to return to step 702.

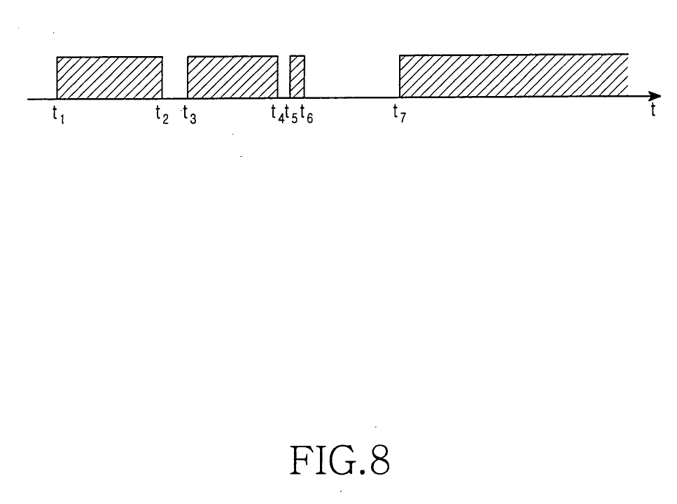

FIG. 8 is a timing diagram illustrating the power control process based on the received interrogation signal in the sleep mode in the mobile communication terminal 200 in accordance with the second embodiment of the present invention. Referring to FIG. 8, a time period between t1 and t2 is a time period in which the mobile communication terminal 200 receives an interrogation signal and generates DC power. A time period between t2 and t3 is a time period in which the generated DC power is incremented to a predetermined threshold value. A time period between t3 and t4 is a time period in which a determination is made as to whether the terminals own ID is included in the interrogation signal. A time period between t5 and t6 is a time period in which a wake-up signal is output. A time period between t6 and t7 is a time period in which the radio receiver 210 is powered on in response to the wake-up signal. A time period from t7 onward is a time period in which a determination is made as to whether the radio receiver 210 has received a radio signal.

In the above-mentioned method for controlling power in a mobile communication terminal in accordance with the second embodiment of the present invention, the terminal receives an interrogation signal from a base station. The mobile communication terminal generates a wake-up signal in response to the received interrogation signal only when its own ID is included in the received interrogation signal. Accordingly, the method for controlling power in the mobile communication terminal in accordance with the second embodiment of the present invention has an advantage in that it can significantly reduce an amount of power consumption in comparison with the conventional method for controlling power in the mobile communication terminal that periodically generates a wake-up signal using battery power. In the power control method in accordance with the second embodiment of the present invention, the mobile communication terminal generates the wake-up signal according to the presence of its own ID although the interrogation signal is received. Accordingly, the power control method in accordance with the second embodiment of the present invention has an advantage in that the wake-up signal is generated only when needed.

The present invention generates power and a wake-up signal using an RFID tag without periodically generating the wake-up signal using limited battery power in the sleep mode. Accordingly, the present invention can reduce an amount of power consumption in the mobile communication terminal.

In accordance with the present invention, the mobile communication terminal generates a wake-up signal in response to a received interrogation signal only when its own ID is included in the received interrogation signal. Accordingly, the present invention can generate the wake-up signal only when it is needed.

Although preferred embodiments of the present invention have been disclosed for illustrative purposes, those skilled in the art will appreciate that various modifications, additions and substitutions are possible, without departing from the scope of the present invention. Therefore, the present invention is not limited to the above-described embodiments, but is defined by the following claims, along with their full scope of equivalents.

What is claimed is:

1. An apparatus for controlling power in sleep mode in a mobile communication terminal, comprising:
a radio communicator for converting a radio signal received through an antenna into a baseband signal using a reference oscillating frequency of a voltage controlled oscillator;
a power supply for supplying power to the radio communicator;
a radio frequency identification (RFID) tag for receiving an interrogation signal from a base station and generating power using the received interrogation signal, and outputting a wake-up signal to be used to determine whether a radio signal has been received using the generated power; and
a controller for controlling the power supply to supply the power to the radio communicator in response to the wake-up signal from the RFID tag.

2. The apparatus according to claim 1, wherein the radio communicator comprises:
a radio receiver for converting the radio signal received through the antenna into an intermediate frequency (IF) signal using the reference oscillating frequency, and outputting the IF signal;
a baseband analog (BBA) processor for converting the IF signal output from the radio receiver into the baseband signal; and
the voltage controlled oscillator for providing the reference oscillating frequency to the radio receiver.

3. The apparatus according to claim 1, wherein the controller checks the baseband signal output from the radio communicator, terminates the sleep mode when a desired received signal is present, and maintains the sleep mode when a desired received signal is absent.

4. The apparatus according to claim 1, wherein the RFID tag comprises:
an interrogation signal receiver for receiving the interrogation signal from the base station;
a power generator for converting the interrogation signal received by the interrogation signal receiver into a direct current (DC) and generating DC power; and
a wake-up signal generator for receiving the DC power from the power generator and generating the wake-up signal.

5. The apparatus according to claim 1, wherein an output intensity of the interrogation signal from the base station is decided according to a reception radius of the mobile communication terminal.

6. The apparatus according to claim 1, wherein the interrogation signal from the base station includes an identification (ID) of a mobile communication terminal targeted to receive the interrogation signal.

7. A method for controlling power in sleep mode in a mobile communication terminal, comprising the steps of:
receiving, from a base station, an interrogation signal for power control in the sleep mode;
generating power using the received interrogation signal; and
generating a wake-up signal to determine whether a radio signal has been received using the generated power.

8. The method according to claim 7, further comprising the steps of:
determining whether a radio signal has been received according to the wake-up signal; and
maintaining the sleep mode if a radio signal destined for the mobile communication terminal has not been received, and terminating the sleep mode if a radio signal destined for the mobile communication terminal has been received.

9. A method for controlling power in sleep mode in a mobile communication terminal, comprising the steps of:
receiving, from a base station, an interrogation signal in the sleep mode, the interrogation signal including at least one specific terminal identification (ID);
generating power using the received interrogation signal;
determining whether the terminal's own ID is included in the interrogation signal using the generated power; and
when the terminal's own ID is included in the interrogation signal, generating a wake-up signal to determine whether a radio signal has been received.

10. The method according to claim 9, further comprising the steps of:
determining whether a radio signal has been received according to the wake-up signal; and
maintaining the sleep mode if a radio signal destined for the mobile communication terminal has not been received, and terminating the sleep mode if a radio signal destined for the mobile communication terminal has been received.
